(19) United States
(12) Patent Application Publication
(10) Pub. No.: US 2008/0175942 A1
(43) Pub. Date: Jul. 24, 2008

(54) Shoe mold with blowing arrangement for injection foam molding

(76) Inventor: Hsieh Chi-Jin, Fongyuan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/656,096

(22) Filed: Jan. 22, 2007

(51) Int. Cl. B29C 44/02

(52) U.S. Cl. 425/4 C

(57) ABSTRACT

A mold for making a shoe body in a process of injection foam molding is disclosed and includes a base; a lower mold body on the base; an upper die together with the mold body to form a mold cavity; an opening mechanism; a cover on the die and secured by the opening mechanism; a cooling plate under the mold body; and a platen pressed onto the cover. Pressurized gas is supplied from a first source to the cavity, molten materials from a second source are forced into the cavity to mix with the pressurized gas, after feeding a predetermined amount of the molten materials to the cavity, the first and the second sources are deactivated for releasing the pressurized gas, and the molten materials expand to shape and produce the finished shoe body.

### BACKGROUND OF THE INVENTION

1. Field of Invention

The invention relates to injection foam molding and more particularly to a shoe mold having a blowing arrangement for injection foam molding with improved characteristics.

2. Description of Related Art

Precision is required for shoe molds. However, conventional shoe molds have the following disadvantages. For example, opening or closing of the mold is only semi-automatic. Thus, it is yield is low. Further, the heated, syrup resins of thermoplastic substances tend to quickly expand as it enters the mold. That is, a substantial portion of the mold is occupied by the expanded resins which inject into the mold first. And in turn, it can hinder or even stop following resins from entering the mold. As a result, in many times a complete shoe cannot be shaped and produced. Furthermore, there are too many bubbles inside the formed shoe which can reduce the structural strength of the shoe. In addition, its appearance is not aesthetic. Thus, the need for improvement still exists.

### SUMMARY OF THE INVENTION

It is therefore one object of the invention to provide a mold for making a shoe body in a process of injection foam molding, comprising a base; a lower mold body mounted on the base and including a top recess, a closed flange around the recess, a closed groove around the flange and spaced from the recess, the groove having a plurality of tunnels being in communication with the flange, a bottom space, a plurality of connection tubes being in communication with the space and the groove, and a lateral first outlet vent extending from the groove and open to a side of the mold body; an upper die mounted on the mold body and including a sprue, a top passage net, a seal adhered around the passage net, a plurality of channels through the die, a connection duct interconnecting the channels and the passage net, a first runner being in communication with the passage net, and a bottom protrusion having a predetermined pattern formed thereunder, wherein a cavity is formed between the protrusion and the recess; an opening mechanism secured to the die and pivotably secured to the base; a hydraulic cylinder pivotably secured to the opening mechanism and including an extendable plunger rod pivotably secured to the base, wherein the cylinder is adapted to activate to either retract the plunger rod a first predetermined distance for opening the mold or extending the plunger rod the first predetermined distance for closing the mold; a cover mounted on the die and secured by the opening mechanism and including a second runner along a lengthwise center line, a third runner being in communication with the second runner and the passage net, and a second outlet vent; a cooling plate mounted under the mold body and including a plurality of vessels being in fluid communication with a cooling source; and a platen pressed onto the cover and including a projecting injection tube, wherein (i) pressurized gas is supplied from a first source to the cavity through the injection tube, the second outlet vent, the passage net, the channels, and the protrusion; (ii) molten materials from a second source are forced into the cavity through the sprue, the second runner, the third runner, and the first runner to mix with the pressurized gas; (iii) after feeding a predetermined amount of the molten materials to the cavity, the first and the second sources are deactivated for releasing the pressurized gas from the cavity through the tunnels, one side of the groove, the connection tubes at one side, the space, the connection tubes at the other side, the other side of the groove, the first outlet vent; and (iv) the molten materials expand to shape and produce the finished shoe body.

The above and other objects, features and advantages of the invention will become apparent from the following detailed description taken with the accompanying drawings.

### BRIEF DESCRIPTION OF THE DRAWINGS

FIG. 1 is an exploded perspective view of a preferred embodiment of shoe mold according to the invention;

FIG. 2 is a perspective view of the assembled mold of FIG. 1;

FIG. 3 is a side elevation of the mold of FIG. 2 being opened;

FIG. 4 is a view similar to FIG. 3 where the mold is closed;

FIG. 5 is another perspective view of the mold but viewed oppositely;

FIG. 6 is another exploded perspective view of the mold;

FIG. 7 is a sectional view taken along line 7-7 of FIG. 5;

FIG. 8 is a sectional view taken along line 8-8 of FIG. 5;

FIG. 9 is a view similar to FIG. 8 where resins are accumulated in the mold cavity; and

FIG. 10 is a view similar to FIG. 8 where a shoe body has been shaped in the mold cavity.

### DETAILED DESCRIPTION OF THE INVENTION

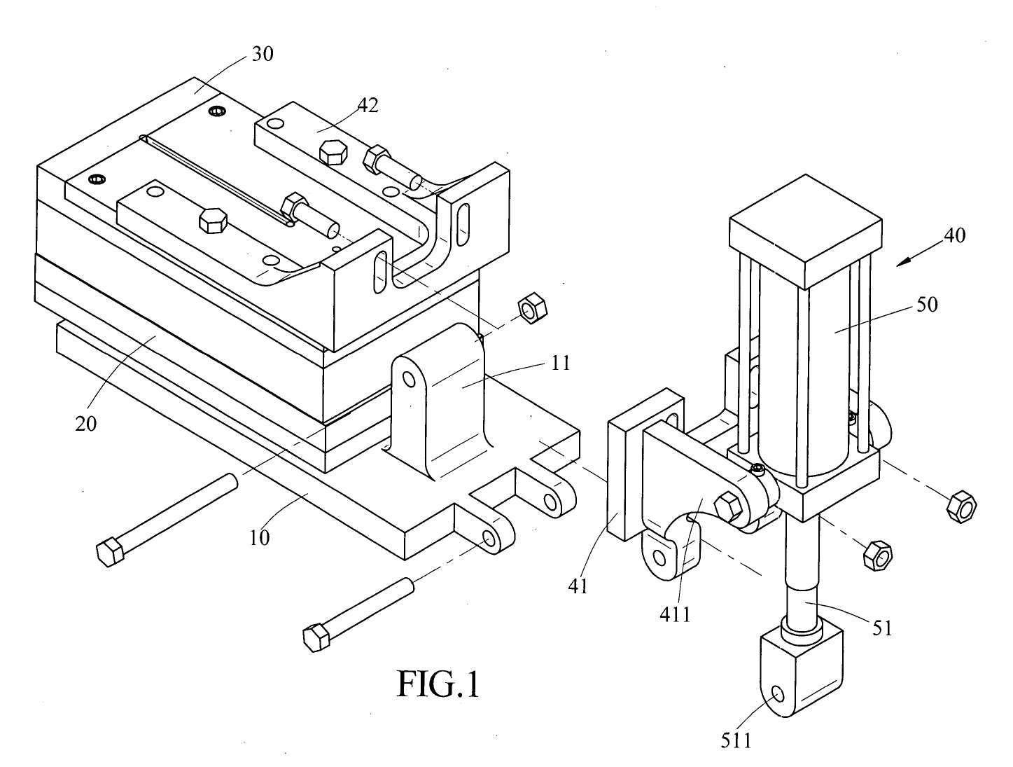

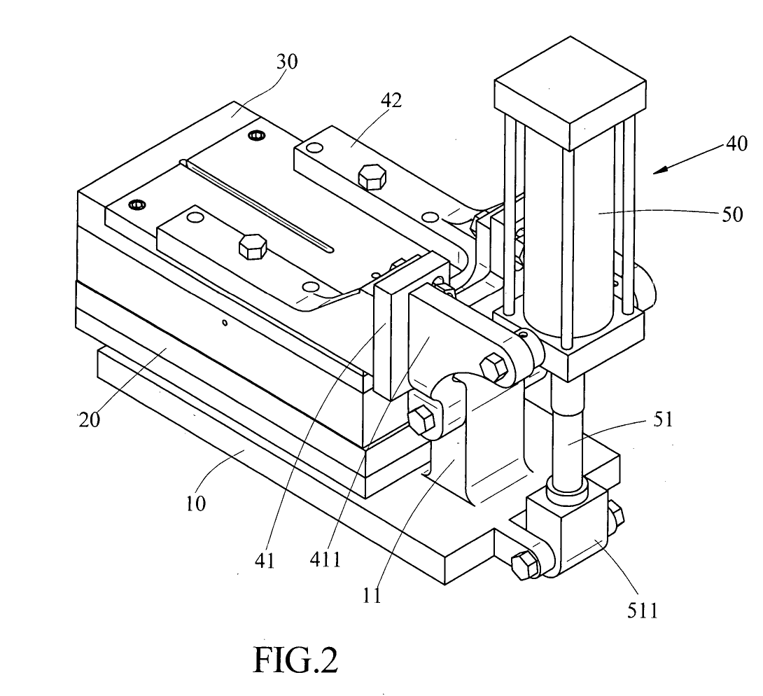

Referring to FIGS. 1 and 2, a shoe mold in accordance with a preferred embodiment of the invention comprises the following components.

A rectangular base 10 comprises an upright projection 11 having a transverse hole (not numbered). A lower mold body 20 is mounted on the base 10. An upper die 30 is matingly mounted on the mold body 20. A mold opening mechanism 40 comprises an engagement plate 41 having two side arms 411 extending rearward and two short yoke arms (not numbered) pivotably secured to the transverse hole of the projection 11 by means of a pin (not numbered) and a nut (not numbered), and a forward yoke 42 having two branches secured to a top of the die 30 and a joining portion adjustably secured to the engagement plate 41 by driving a threaded fastener (e.g., screw) through either elongate hole (not numbered) of the yoke 42 into either threaded hole (not shown) of the engagement plate 41. A hydraulic cylinder 50 is pivotably fastened between two rear ends of the arms 411 and comprises a plunger rod 51 extending downward, the plunger rod 51 having an enlarged end 511 pivotably secured to a rear yoke (not numbered) of the base 10 by means of a pin (not numbered) and a nut (not numbered). Moreover, a cooling device (not shown) is provided under the mold body 20.

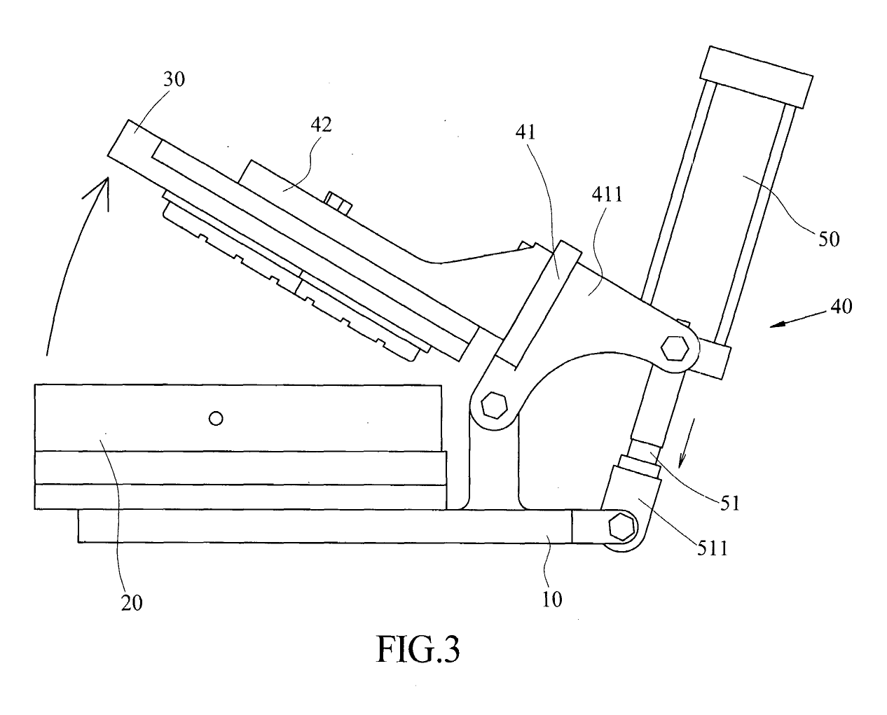

Referring to FIG. 3, in one operation the cylinder 50 is activated to decrease a length of the plunger rod 51 projecting out of the cylinder 50. And in turn, the engagement plate 41 pivots clockwise about the base 10 and the die 30 also pivots clockwise relative to the mold body 20. As a result, the mold is opened.

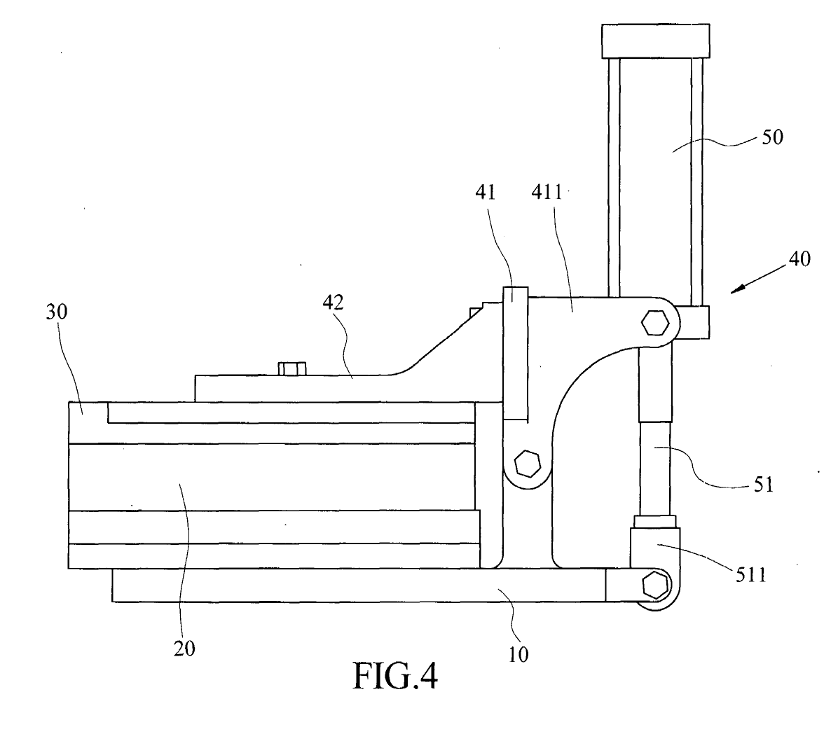

Referring to FIG. 4, to the contrary the cylinder 50 can be activated to increase the length of the plunger rod 51 projecting out of the cylinder 50. And in turn, the engagement plate 41 pivots counterclockwise about the base 10 and the die 30 also pivots counterclockwise relative to the mold body 20. As a result, the mold is closed.

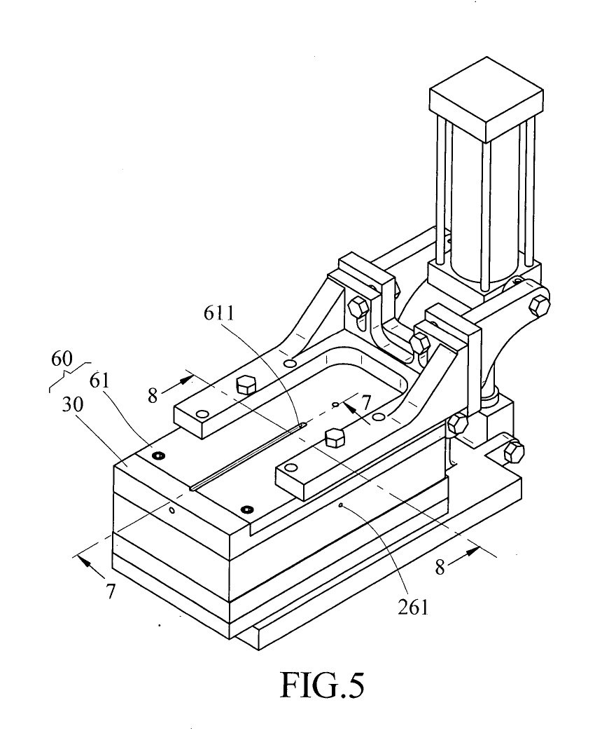

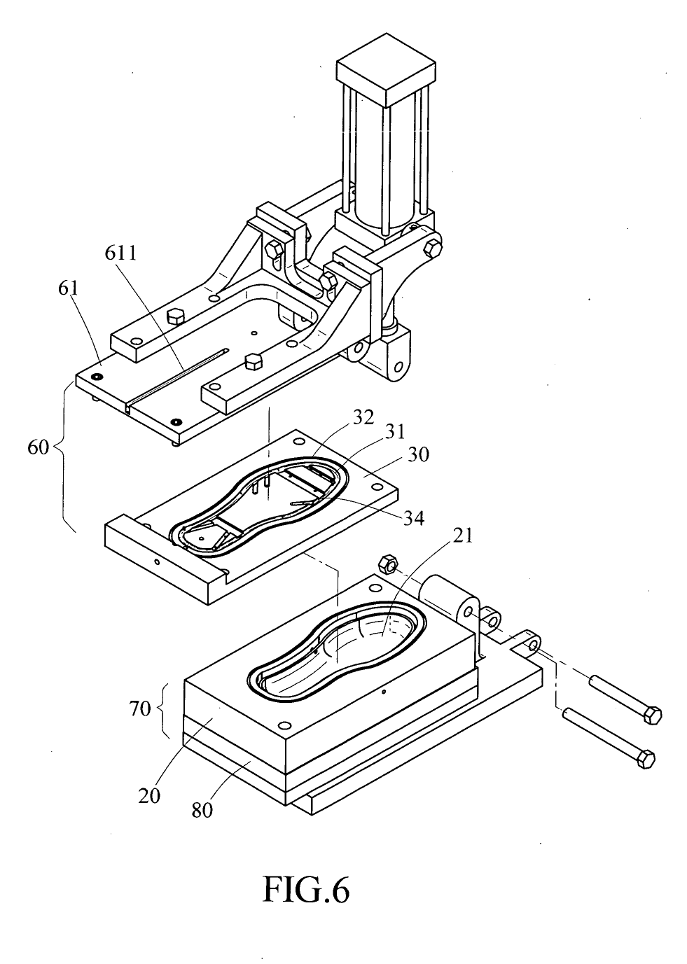

Referring to FIGS. 5 to 8, the shoe mold further comprises the following components.

An upper seat 60 consists of the die 30 and a rectangular cover 61 matingly secured to the die 30. The cover 61 comprises an elongate first runner 611 along a lengthwise center line and open to a top, a second runner 612 being in communication with the first runner 611 and about perpendicular to the first runner 611, and a first outlet vent 613 open to the top. The rectangular die 30 comprises a top passage net 31 including a closed passage and a plurality of transverse passageways surrounded by the passage and being in communication therewith, a rubber seal 32 adhered around the passage net 31, a plurality of parallel gas channels 33 through the die 30, a connection duct 34 interconnecting the channels 33 and the passage net 31, a third runner 35 aligned with and being in communication with the second runner 612 and the passage net 31, a bottom protrusion 36 having a predetermined pattern, two opposite first edge members 37 proximate front and rear ends of the protrusion 36, and two opposite second edge members 38 at the front and rear ends of the protrusion 36 and adjacent the first edge members 37.

A lower bed 70 consists of the mold body 20 and a rectangular cooling plate 80 secured to the mold body 20. The mold body 20 comprises a top recess 21 shaped to conform to the sole of a shoe, a closed flange 22 around the recess 21, a closed groove 23 around the flange 22 and spaced from the recess 21, the groove 23 being in communication with the flange 22 through a plurality of tunnels 221, a bottom space 25, a plurality of connection tubes 24 being in communication with both the space 25 and the groove 23, and a lateral second outlet vent 26 extending from the groove 23 and having a mouth 261 open to a side of the mold body 20. The cooling plate 80 is comprised of a plurality of vessels which are in fluid communication with a cooling water pipe 81. In operation, water is cyclically carried from the cooling water pipe 81 to the cooling plate 80 for cooling the mold.

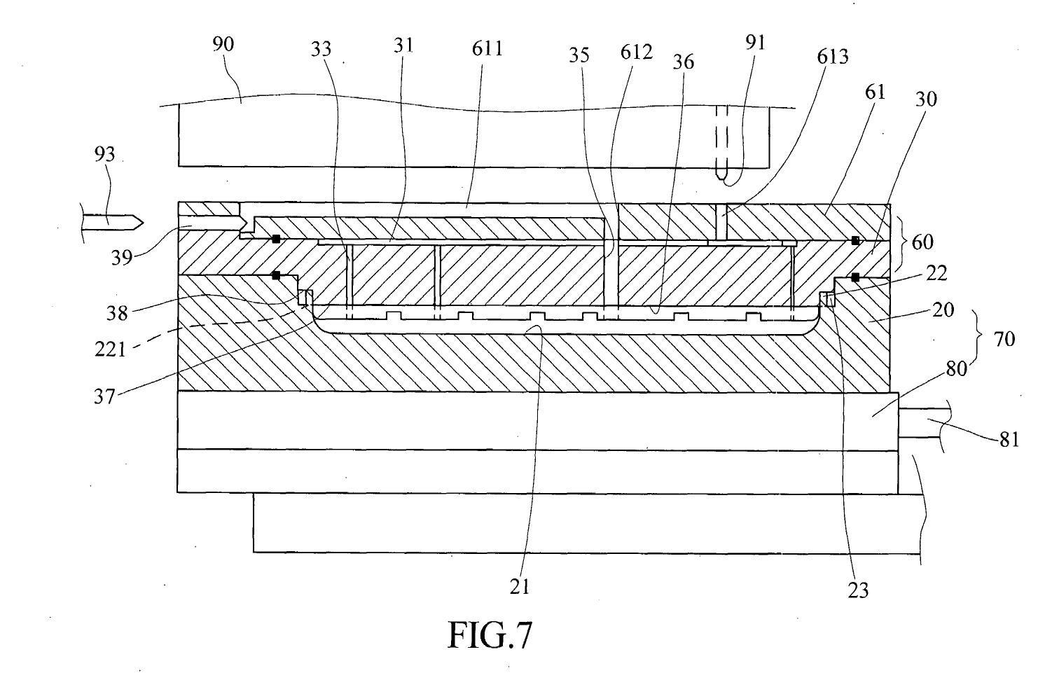

Referring to FIG. 7 specifically, a platen 90 is pressed onto the seat 60 for closing the first runner 611 in the process of injection foam molding. The provision of the first runner 611 is to clear hardened residue in the mold after the process of injection foam molding.

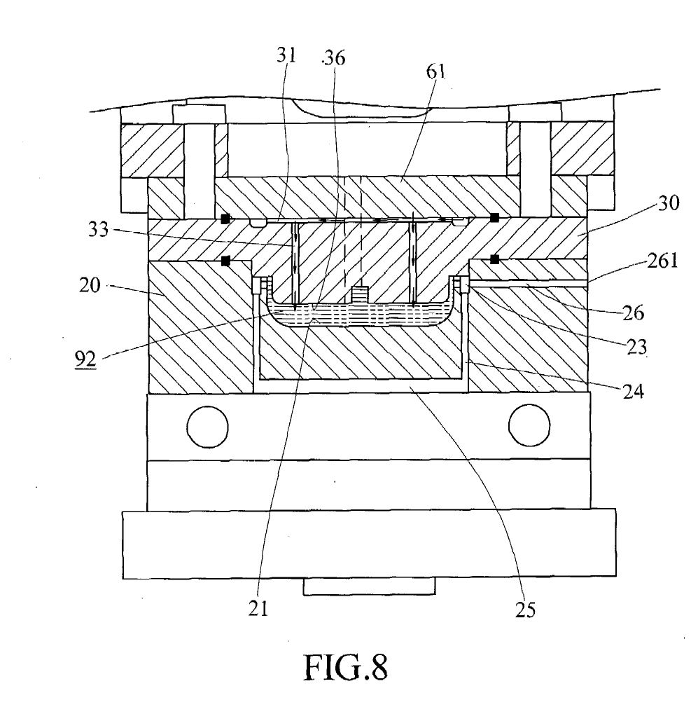

Referring to FIGS. 7 and 8 specifically, the platen 90 comprises a projecting injection tube 91 adapted to insert into the first outlet vent 613 for feeding pressurized gas (e.g., air) thereinto. The pressurized air then sequentially enters the passage net 31, the channels 33, and a cavity 92 formed between the recess 21 and the protrusion 36. A feeding tube 93 is inserted into a sprue 39. Thereafter, the molten resins of thermoplastic are fed from the feeding tube 93 into the cavity 92 through the sprue 39, the first runner 611, the second runner 612, and the third runner 35 sequentially. The molten resins are adapted to mix with the pressurized air.

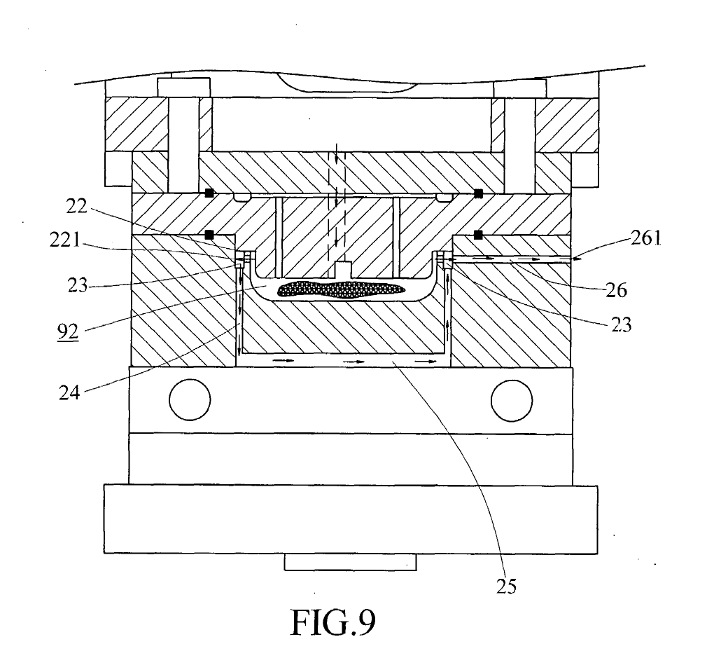

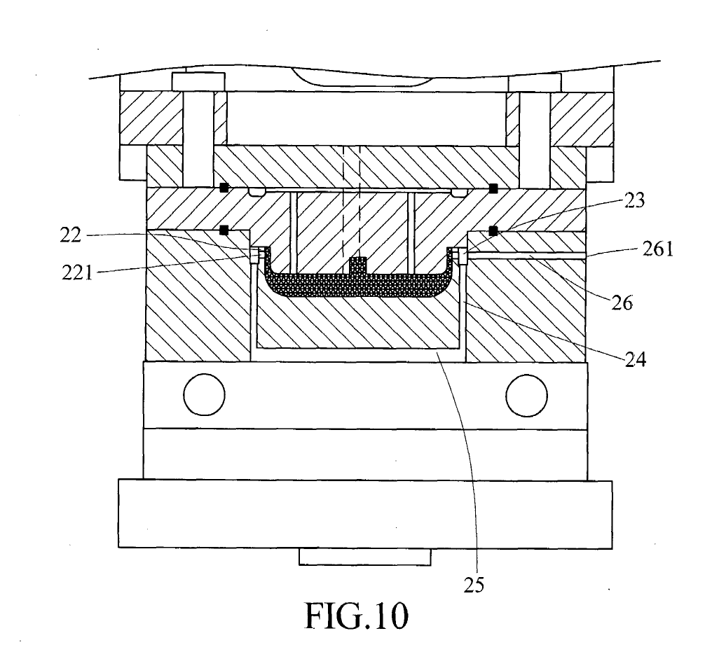

Referring to FIGS. 9 and 10, after feeding a predetermined amount of molten resins to the mold, the feeding tube 93 is removed. Also, the pressurized air fed from a source (e.g., air compressor) is stopped and the injection tube 91 is removed from the first outlet vent 613. At the same time, the pressurized air is released from the cavity 92 through the tunnels 221, one side of the groove 23, the connection tubes 24 at one side, the space 25, the connection tubes 24 at the other side, the other side of the groove 23, the second outlet vent 26, and the mouth 261. The resins then begin to expand to shape and form a molded part (e.g., a complete shoe body) in the cavity 92 as shown in FIG. 10. The shoe body has a rigid skin and a cellular internal structure.

The invention has the following advantages. Yield is high. Quality is improved. Appearance is aesthetic. Structural strength is increased significantly. Good dimensional accuracy can be achieved.

While the invention herein disclosed has been described by means of specific embodiments, numerous modifications and variations could be made thereto by those skilled in the art without departing from the scope and spirit of the invention set forth in the claims.

What is claimed is:

1. A mold for making a shoe body in a process of injection foam molding, comprising:
a base including an upright projection;
an upper seat including an upper die and a cover secured to the upper die, wherein the cover includes a first runner, a second runner being in communication with the first runner, and a first outlet vent open to a top, and wherein the upper die includes a top passage net, a plurality of parallel gas channels through the upper die and being in communication with the passage net, a third runner aligned with and being in communication with the second runner and the passage net, a bottom protrusion having a predetermined pattern, two opposite first edge members proximate front and rear ends of the protrusion, and two opposite second edge members at the front and rear ends of the protrusion and adjacent the first edge members;
a lower bed including a lower mold body and a cooling plate secured to the lower mold body, wherein the lower mold body including a top recess shaped to conform to the sole of a shoe, a closed flange around the recess and including a plurality of tunnels, a closed groove around the flange and spaced from the recess, the groove being in communication with the flange through the tunnels, a bottom space, a plurality of connection tubes being in communication with the space and the groove, and a lateral first outlet vent extending from the groove and open to a side of the lower mold body;
an opening mechanism including an engagement plate having two side arms, and a forward yoke secured to a top of the upper die, wherein the forward yoke has a joining portion adjustably secured to the engagement plate, and wherein the engagement plate is pivotably secured to the projection; and
a hydraulic cylinder pivotably fastened between two rear ends of the arms and including an extendable plunger rod pivotably secured to the base, wherein the cylinder is adapted to activate to either retract the plunger rod a first predetermined distance for opening the mold or extending the plunger rod the first predetermined distance for closing the mold.

2. The mold of claim 1, where the first runner is open to the top of the cover.

3. The mold of claim 1, wherein the upper die further comprises a rubber seal adhered around the passage net.

4. The mold of claim 1, wherein the upper die further comprises a connection duct interconnecting the channels and the passage net.

5. The mold of claim 1, wherein the cooling plate comprises a cooling water pipe open to the lower mold body, and a plurality of vessels being in fluid communication with a cooling water pipe.

6. The mold of claim 1, further comprising a platen adapted to press onto the seat for closing the first runner in the process of injection foam molding, the platen including a projecting injection tube adapted to insert into the first outlet vent for feeding pressurized gas thereinto.
